(19) United States
(12) Patent Application Publication
(10) Pub. No.: US 2010/0017419 A1
(43) Pub. Date: Jan. 21, 2010

(54) Systems and Methods for Distributed Asset Management Having Tagging Capabilities

(75) Inventors: Brett M. Francis, Redwood City, CA (US); Clifford N. Baumann, San Jose, CA (US); Robert G. Fox, Berkeley, CA (US)

Correspondence Address: Nixon Peabody LLP, P.O. Box 60610, Palo Alto, CA, 94306, US

(73) Assignee: FAT SPANIEL TECHNOLOGIES, INC., San Jose, CA (US)

(21) Appl. No.: 12/173,727

(22) Filed: Jul. 15, 2008

(51) Int. Cl. G06F 17/30; G06Q 10/00

(52) U.S. Cl. 707/100; 705/1; 707/E17.009

(57) ABSTRACT

Distributed asset management may be achieved as described herein by representing within a computer database system a collection of distributed assets, and logging within the computer database system time-series data sent from different ones of the distributed assets. Input from authorized users is accepted and stored in the form of tags, each tag being associated with an asset or group of assets. Access is provided to the time-series data or data derived therefrom, and to the tags, by the authorized users. By providing tagging capabilities, diverse requirements of different audiences are supported, and a system can be created wherein the different needs and interests of the audiences are satisfied in such a way as to produce a multiplying beneficial effect. At the same time, complexities are minimized that would otherwise be introduced in order support different taxonomies within a changing heterogeneous environment. Tagging may include such examples as tagging of assets, of time-series data generated by assets, and of pre-defined envelopes of time-series data.

### TECHNICAL FIELD

The present disclosure relates generally to distributed asset management.

### BACKGROUND

When distributed assets generate time-series information needed by a dynamically changing, heterogeneous set of audiences, that asset information and time-series information is under pressure to be categorized within taxonomies driven by different business models, corporate processes, agency requirements and market needs. One example of such an application is the renewable and distributed energy generation industry. Interested parties in this marketplace may include owners, investors, installers and integrators, OEMs, regulators, service providers, etc. An information system is desired to help coordinate between and further the interests of these various parties (e.g., help improve efficiencies, lower costs, facilitate new services, facilitate management and improvement of the energy production and distribution system as a whole, facilitate energy commerce, etc.). Satisfying the diverse needs of various interested parties, however, becomes a complex challenge.

### OVERVIEW

Distributed asset management may be achieved as described herein by representing within a computer database system a collection of distributed assets, and logging within the computer database system time-series data sent from different ones of the distributed assets. Input from authorized users is accepted and stored in the form of tags, each tag being associated with an asset or group of assets. Access is provided to the time-series data or data derived therefrom, and to the tags, by the authorized users. By providing tagging capabilities, diverse requirements of different audiences are supported, and a system can be created wherein the different needs and interests of the audiences are satisfied in such a way as to produce a multiplying beneficial effect. At the same time, complexities are minimized that would otherwise be introduced in order support different taxonomies within a changing heterogeneous environment. Tagging may include such examples as tagging of assets, of time-series data generated by assets, and of pre-defined envelopes of time-series data.

### BRIEF DESCRIPTION OF THE DRAWINGS

The accompanying drawings, which are incorporated into and constitute a part of this specification, illustrate one or more examples of embodiments and, together with the description of example embodiments, serve to explain the principles and implementations of the embodiments.

In the drawings:

FIG. 1 illustrates an example system for distributed asset management.

FIG. 2 illustrates methods of interacting with the system of FIG. 1.

FIG. 3 illustrates an example of tagging information stored within the distributed asset management system.

FIG. 4 illustrates a further example of tagging information stored within the distributed asset management system.

FIG. 5 illustrates a further example of tagging information stored within the distributed asset management system.

FIG. 6 illustrates an example display that may be displayed for tagging information stored within the distributed asset management system.

FIG. 7 illustrates a further example display that may be displayed for tagging information stored within the distributed asset management system.

FIG. 8 illustrates a further example display that may be displayed for tagging information stored within the distributed asset management system.

### DESCRIPTION OF EXAMPLE EMBODIMENTS

Example embodiments are described herein in the context of a distributed asset management system for renewable energy and distributed energy generation systems. Those of ordinary skill in the art will realize that the following description is illustrative only and is not intended to be in any way limiting. Other embodiments will readily suggest themselves to such skilled persons having the benefit of this disclosure. Reference will now be made in detail to implementations of the example embodiments as illustrated in the accompanying drawings. The same reference indicators will be used to the extent possible throughout the drawings and the following description to refer to the same or like items.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with this disclosure, the components, process steps, and/or data structures described herein may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Eraseable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card, paper tape and the like) and other types of program memory.

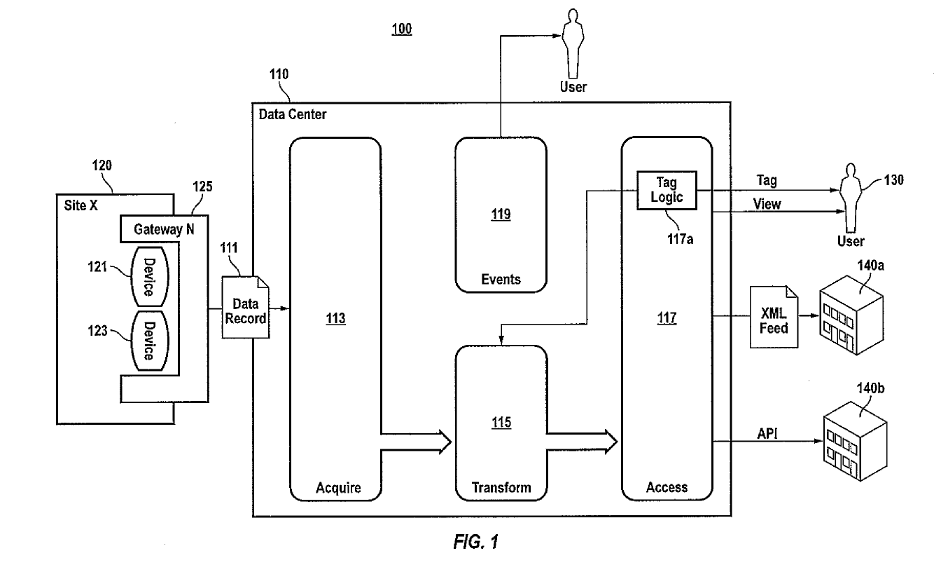

A “distributed asset management system” as defined herein is a system that allows assets at different sites to be centrally monitored or controlled. The assets may be any of myriad different types. Referring now to FIG. 1, an example is shown of a system 100 for distributed asset management. The system may include software running on one or more server computers located at a data center 110, for example. The data center may be a collection of inter-operating computers or may be a single computer. (One example is a SAS-70 Type II certified data center.) Distributed assets to be managed are assumed to be located at various sites. For purposes of illustration, a single site 120 (“Site X”) is illustrated. Site 120 may include any number of devices (also referred to as “assets”) to be managed. Site 120 is shown as including two devices 121 and 123. Of course, in practice, the number of devices located at a particular site may be much greater.

A communication gateway 125 of a known type (“Gateway N”) may be provided to enable communications between the site 120 and the data center 110. The gateway 125 repeatedly, preferably continuously, receives data from one or more of the devices 121 and 123 at frequent intervals and sends that data to the data center 110 in the form of a data record 111. The data is referred to as “time-series data,” and may be used to record the status of a device at as fine an interval as desired, for example on a minute-by-minute or second-by-second basis. When the devices are energy-producing assets, for example, the time-series data may be used to describe the power output of the devices over time.

Selected functions of software running at the data center 110 are illustrated in FIG. 1. When a data record arrives at the data center 110, a portion 113 of the software operates as a data logger to store, or acquire, the raw data. The raw data, however, is typically unsuitable to be viewed or manipulated. In order to allow the data to be viewed or manipulated in various ways as may be desired by users of the system, the raw data is transformed by a portion 115 of the software. One example of such a transformation is to combine the data of selected channels of data from a power inverter relating respectively to different phases of the inverter, and to combine the data of the selected channels so as to calculate the power output of the inverter. Various other kinds of transformations may also be performed in anticipation of various ways users may wish to view and interact with the data. How the data is to be transformed will depend on the type of asset that produced the data. Various assets types may be defined to enable data from a broad array of asset types to be transformed so as to be meaningfully displayed to users. Prior to or as part of transformation, the data may be “parsed” or filtered, resulting in data that is of higher information content.

A portion 117 of the software allows the transformed data to be viewed and manipulated. Viewing may be supported in different ways. For example, a user 130 may interact with software running at the data center 110 through a web browser in order to receive data in a suitable format (e.g., HTML, FLASH, etc.) to be rendered and viewed on the user's computer (not shown). Alternatively, data processing equipment at locations 140a, 140b may interact with software running at the data center 110 through a published application program interface (API) in order to receive data in a suitable format to be processed and made available to users in any of a variety of different ways. This type of interaction may be a purely mechanized, static interaction (resulting, for example, in an XML feed); or the interaction may be a dynamic, request-driven interaction.

The portion 117 of the software also includes tag logic 117a and enables users (or machines) to apply tags to assets, groups of assets, envelopes of data produced by assets or groups of assets, etc., all as described more fully hereinafter.

A portion 119 of the software analyzes the raw data, the transformed data, or both in order to identify events of interest to users. An obvious example is an outage in which a power-producing asset has ceased to produce power, or has experienced an appreciable reduction in power output. Users may be notified of events by any of various mechanisms, including email, Short Message Service (SMS), Instant Messaging (IM), automated voice messaging, etc.

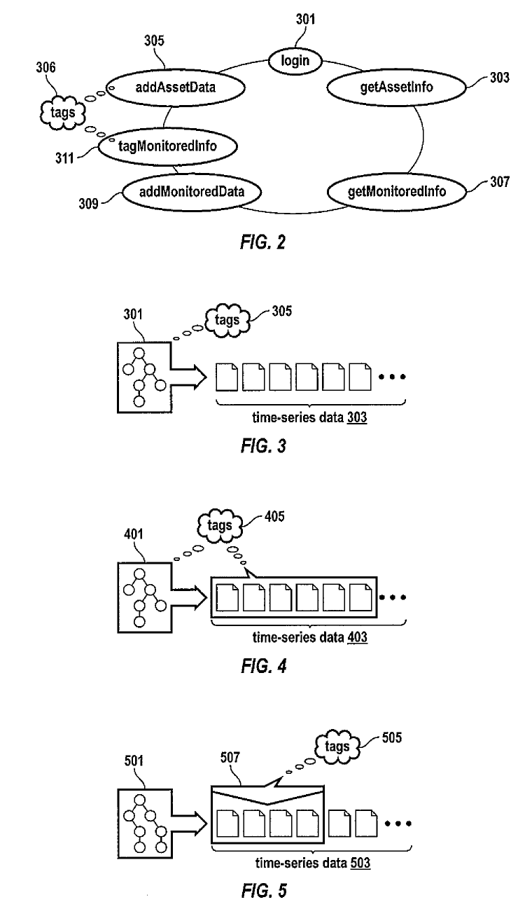

Referring to FIG. 2, selected methods of interacting with the system of FIG. 1 are shown. Authorized users or systems are able perform a login operation 301 to log into the system of FIG. 1 and perform various operations to get data, add data, or tag data. A getAssetInfo operation 303 enables information concerning assets to be retrieved; conversely, an addAssetData operation 305 enables data concerning assets to be added to the system. A getMonitoredInfo operation 307 enables monitored data collected from assets to be retrieved; conversely, an addMonitoredData operation 309 enables monitored data collected from assets to be added to the system. The addAssetData operation 305 may be used to add tags 306 to asset data. A tagMonitoredInfo operation 311 may be used to add tags to time-series data and envelopes.

As described by Wikipedia:

A tag is a non-hierarchical keyword or term assigned to a piece of information (such as an internet bookmark, digital image, or computer file). This kind of metadata helps describe an item and allows it to be found again by browsing or searching. Tags are chosen informally and personally by the item's creator or by its viewer, depending on the system. On a website in which many users tag many items, this collection of tags becomes a folksonomy. Tags may be of various types.

A triple tag is a tag that uses a special syntax to define extra information about the tag, making it easier or more meaningful for interpretation by a computer program.

A tag cloud is a visual depiction of a set of related tags with corresponding weights.

When a tag is a keyword adopted to make relevant materials searchable in a uniform way, the tag is part of a “controlled vocabulary.”

In addition to the foregoing well-known tag concepts described by Wikipedia, it is useful to define a “propagating tag.” A propagating tag (as used herein) is a tag that is itself associated with a tag “propagate” or, when supporting use in an internationalized system, an additional Boolean state propagate=true|false may be used. Any time-series data produced by an asset or asset hierarchy with which a propagating tag is associated or affirmatively enabled will automatically have the propagating tag associated.

Tagging may advantageously be applied to the system of FIG. 1 in various ways, as illustrated in FIGS. 3-5.

“Community asset tagging” is illustrated in FIG. 3. An authorized party browses through a representation of the hierarchy of assets 301 installed in a single location or multiple locations. The assets have associated with them time-series data 303. When the authorized party chooses to classify or annotate an asset with a tag they may select a tag from an existing set of tags within an available tag cloud or create a tag by typing it in directly. Different authorized parties might only be allowed to tag assets within a hierarchy that fit within a particular asset type or broader based asset classifications. As a result, tags 305 become associated with the asset or hierarchy of assets 301.

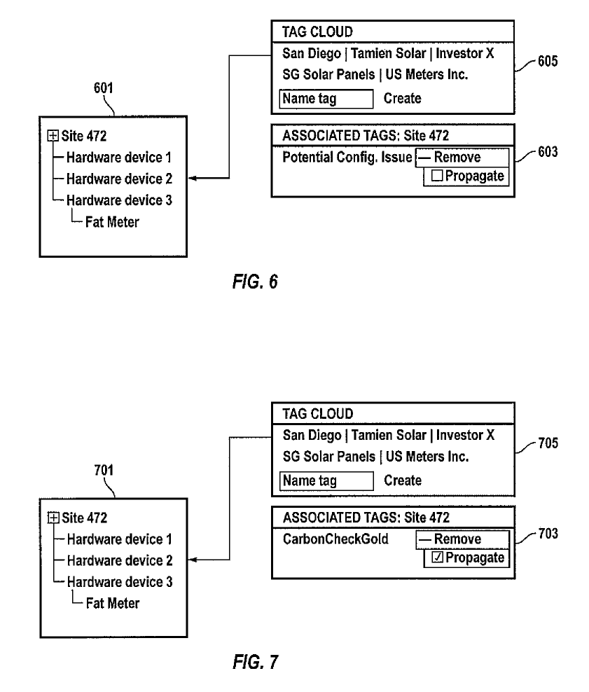

A representative screen display that may be used for community asset tagging is illustrated in FIG. 6. The user has navigated through a portfolio of distributed sites and has selected a Site 472, which has been expanded to display within a panel 601 hardware devices associated with Site 472. Within a panel 603 are displayed tags associated with Site 472. In the illustrated example, Site 472 has been tagged to indicate a potential configuration issue. Within a panel 605 is displayed a tag cloud showing a set of previously entered tags, in this case name tags of locations, investors, company names, etc.

Automatic time-series data tagging based on a propagating tag is illustrated in FIG. 4. Time-series data 403 produced by an asset or asset hierarchy 401 tagged with a propagating tag 405 automatically has the propagating tag 405 associated.

A representative screen display that may be used for automatic time-series data tagging is illustrated in FIG. 7. The user has navigated through a portfolio of distributed sites and has selected a Site 472, which has been expanded to display within a panel 701 hardware devices associated with Site 472. Within a panel 703 are displayed tags associated with Site 472. In the illustrated example, Site 472 has been tagged with the propagating tag CarbonCheckGold indicating a specified level of regulatory compliance. Within a panel 705 is displayed the tag cloud.

Time-series envelope tagging is illustrated in FIG. 5. A time-series 503 of data points or records each possesses a sequence ID. A time-series envelope 507 contains a set of time-series record sequence IDs of which the envelope is comprised. The envelope itself is given an ID. Once a time-series data envelope 507 is created it may be associated with additional information beyond time-series data such as tags 505. In the case of time-series envelope tagging, tags or a controlled vocabulary of official tags are exposed to an authorized party, for example visually within a tag cloud or through documentation or community knowledge. Controlled vocabularies are associated with domains of third parties as defined by the role obtained by the party upon login. These domains might include carbon trading trust companies, carbon market regulatory compliance agencies, or any other domain of third parties authorized to tag the time-series envelope.

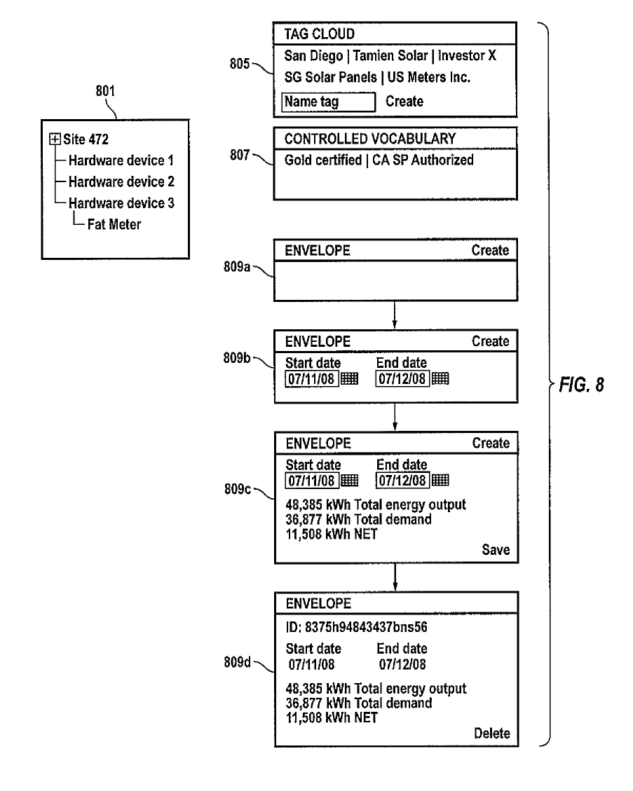

A representative screen display that may be used for time-series envelope creation and tagging is illustrated in FIG. 8. The user has navigated through a portfolio of distributed sites and has selected a Site 472, which has been expanded to display within a panel 701 hardware devices associated with Site 472. Within a panel 805 is displayed a tag cloud showing a set of related tags, in this case name tags of locations, users, etc. Within a panel 807 is displayed a controlled vocabulary, or collection keywords adopted to make searching in a uniform way possible. A succession of panels 809a-d show creation of an envelope. In panel 809a, creation of the envelope has been initiated. In panel 809b, start and end dates for the envelope are specified. In panel 809c, energy statistics in relation to data contained in the envelope as defined are displayed. In panel 809d, the envelope has been saved and assigned a unique envelope ID.

### EXAMPLES

### Example 1

An authorized party named Claire is associated with the manufacturer of an asset type named Fat Meter. Upon accessing a distributed asset management system Claire browses assets of type Fat Meter and notices a peculiar configuration associated with a particular asset instance. The configuration is known to sometimes cause an issue known by the manufacturer and Claire tags the peculiarly configured asset as “potential config issue”. This tag is then associated with the particular asset and classified as being added by the manufacturer. Later that day the authorized party named Rosie, responsible for the care of the portfolio of distributed assets within which the specific instance of Fat Meter that is configured in a peculiar way resides, accesses the distributed asset management system and is shown that an asset in their portfolio has recently been tagged by the manufacturer. Upon investigation Rosie notices the tag “potential config issue” and places a phone call to the manufacturer to explore a course of action.

### Example 2

An authorized party named Sadie from EnergyPPA browses through the portfolio of owned sites. While browsing, Sadie associates a tag of “InvestorX” with each site for which InvestorX has invested. Later Sadie browses through the portfolio of owned sites and associates a tag of “JoesSolarInstallations” with any sites where Joe's Solar Installations performed the installation of the site's assets. Finally Sadie runs an energy report of sites owned by EnergyPPA and customizes the report to display only sites where the investor is InvestorX and the installer was Joe's Solar Installations. Sadie performs this customization task simply by selecting the two previously entered tags from the tag cloud displayed alongside the customize report operation.

### Example 3

EnergyPPA has a department of portfolio managers. Each manager is responsible for the performance of a particular subset of sites that are within the complete set of sites owned by EnergyPPA. The portfolio management department head accesses the distributed asset management system and associates a tag of the name of the portfolio managers within the department with each site for which the specific portfolio manager is responsible. When a specific portfolio manager accesses the distributed asset management system they request that the system display only sites tagged with their name.

### Example 4

A propagating tag “CarbonCheckGold” is added to the distributed asset management system by an authorized party. An authorized system associated with a carbon regulatory agency named CarbonCheck accesses the distributed asset management system to convey certification of a particular installation of distributed assets as meeting CabonCheck's regulatory compliance. After final review to determine that the important characteristics of the installation remain in effect, the system annotates the installation with an official tag “CarbonCheckGold”. Upon arrival of the next raw time-series data record describing energy produced by the installation, the time-series data record is automatically tagged with “CarbonCheckGold.”

While embodiments and applications have been shown and described, it would be apparent to those skilled in the art having the benefit of this disclosure that many more modifications than mentioned above are possible without departing from the inventive concepts disclosed herein. The invention, therefore, is not to be restricted except in the spirit of the appended claims.

What is claimed is:

1. A method of distributed asset management, comprising:
representing within a computer database system a collection of distributed assets;
logging within the computer database system time-series data sent from different ones of the distributed assets;
accepting input from authorized users and storing the input in the form of tags, each tag being associated with an asset or group of assets; and
providing access to the time-series data or data derived therefrom, and to the tags, by the authorized users.

2. The method of claim 1, comprising creating and storing a propagating tag associated with a particular distributed asset or group of assets.

3. The method of claim 2, comprising:
receiving time-series data from the particular distributed asset or group of assets; and
based on the propagating tag, automatically associating a tag with the time-series data received from the particular distributed asset or group of assets.

4. The method of claim 1, comprising:
receiving input from an authorized user identifying a set of time-series data; and
associating the set of time-series data to form a time-series envelope.

5. The method of claim 4, comprising:
accepting input from an authorized user relating to an envelope of time-series data; and
storing the input in the form of a tag associated with the envelope of time-series data.

6. The method of claim 1, wherein the assets are energy-producing assets.

7. The method of claim 1, comprising using a published application program interface to retrieve data from the computer database system.

8. A computer readable medium including program instructions for managing distributed assets, said instructions performing steps comprising:
representing within a computer database system a collection of distributed assets;
logging within the computer database system time-series data sent from different ones of the distributed assets;
accepting input from authorized users and storing the input in the form of tags, each tag being associated with an asset or group of assets; and
providing access to the time-series data or data derived therefrom, and to the tags, by the authorized users.

9. The computer readable medium of claim 8, said instructions performing steps comprising creating and storing a propagating tag associated with a particular distributed asset or group of assets.

10. The computer readable medium of claim 9, said instructions performing steps comprising:
receiving time-series data from the particular distributed asset or group of assets; and
based on the propagating tag, automatically associating a tag with the time-series data received from the particular distributed asset or group of assets.

11. The computer readable medium of claim 8, said instructions performing steps comprising:
receiving input from an authorized user identifying a set of time-series data; and
associating the set of time-series data to form a time-series envelope.

12. The computer readable medium of claim 11, said instructions performing steps comprising:
accepting input from an authorized user relating to an envelope of time-series data; and
storing the input in the form of a tag associated with the envelope of time-series data.

13. The computer readable medium of claim 8, wherein the assets are energy-producing assets.

14. The computer readable medium of claim 8, said instructions performing steps comprising using a published application program interface to retrieve data from the computer database system.

15. A distributed asset management system, comprising:
a computer database system representing therein a collection of distributed assets;
a data logger for logging within the computer database system time-series data sent from different ones of the distributed assets; and
a interface for:
accepting input from authorized users and storing the input in the form of tags, each tag being associated with an asset or group of assets; and
providing access to the time-series data or data derived therefrom, and to the tags, by the authorized users.

16. The distributed asset management system of claim 15, wherein the interface provides for creating and storing a propagating tag associated with a particular distributed asset or group of assets.

17. The distributed asset management system of claim 16, comprising logic for:
receiving time-series data from the particular distributed asset or group of assets; and
based on the propagating tag, automatically associating a tag with the time-series data received from the particular distributed asset or group of assets.

18. The distributed asset management system of claim 15, wherein the interface provides for:
receiving input from an authorized user identifying a set of time-series data; and
associating the set of time-series data to form a time-series envelope.

19. The distributed asset management system of claim 18, wherein the interface provides for:
accepting input from an authorized users relating to an envelope of time-series data; and
storing the input in the form of a tag associated with the envelope of time-series data.

20. The distributed asset management system of claim 15, wherein the assets are energy-producing assets.

21. The distributed asset management system of claim 15, wherein the interface provides for using a published application program interface to retrieve data from the computer database system.

22. An information server, comprising one or more computers, for managing distributed assets, comprising:
a computer database system representing therein a collection of distributed assets;
a data logger for logging within the computer database system time-series data sent from different ones of the distributed assets; and
an interface for:
accepting input from authorized users and storing the input in the form of tags, each tag being associated with an asset or group of assets; and
providing access to the time-series data or data derived therefrom, and to the tags, by the authorized users.
